(19) United States
(12) Patent Application Publication
(10) Pub. No.: US 2001/0015752 A1
(43) Pub. Date: Aug. 23, 2001

(54) Device for displaying global images of desired areas

(76) Inventors: Cristian Barnes, Ciudad Autonoma de Buenos Aires (AR); Dante Adrian Castiglione Maldonado, Ciudad Autonoma de Buenos Aires (AR)

Correspondence Address: DARBY & DARBY, P.C., 805 Third Avenue, New York, NY, 10022, US

(21) Appl. No.: 09/754,847

(22) Filed: Jan. 4, 2001

(30) Foreign Application Priority Data
Jan. 17, 2000 (AR) P000100203

(51) Int. Cl. H04N 13/00; H04N 5/89

(52) U.S. Cl. 348/40

(57) ABSTRACT

A device for displaying images of any desired location with the purpose of orientation for an user and for identifying and localizing any desired site, either at land, sea or air, either in the globe, a planet or space, the device comprising a device for displaying an image of the site; an image control device, a device for providing an orientation about the four cardinal points to the image control device, a receiver for receiving signals from a transmission network, and a processor for data from the transmission network.

### BACKGROUND OF THE INVENTION

1. Field of the Invention

The present invention relates to the area of global signal transmissions and the displaying of data and information, preferably in the way of images, from such transmissions and, more particularly the invention refers to a device for displaying images of any area, site or location in the land, the sea or the air in the globe, or even in the space out of the earth, with the purpose that the user of the device is able to get a real view of the area, site, location or any particularity, such as a building, a vehicle and any other element, of the area, with the image provided by the device being orientated in the correct orientation of the cardinal points as it is the real region or area from which the image is recorded. Thus the user is capable of seeing the area, city, neighborhood or street the user is looking for, is also capable of receiving information about this area such as services, buildings, etc.

2. Description of the Prior Art

It is well known in the art of telecommunications to provide several devices for overcoming one or more of the following problems and needs:

to find out the geographic position of a person or machine;

to establish a communication by text, audio and/or image messages.

to see a land map in two or three dimensions;

to store a list of usual communication contacts, and

to have information about the location a person is looking for.

Most of the activities carried out by a person involve a more or less complex combination of several of the above listed needs. That is, in order to get the desired or needed information about the geographic location of the user, particularly in unknown areas or regions, such as in foreign countries, the only means to obtain this information is by using maps, informative guides, information services, (on-line for example), communication devices, geographic positioning means such a combination of compass and sextant, or a global positioning system (GPS).

Except for the use of maps and tourist information services, the use of technological more complex means is not friendly and people are generally reluctant to employ the same. Frequently, these means require of a certain degree of training which is generally of importance for most of the people and, if the user has not an enough training the results are not satisfactory. With the global positioning systems today available, this is not possible as long as the same must be technologically combined with other technology to provide the necessary information for a user. There is no devices in the market combining all the necessary technology to allow a user to obtain the real image and information of a desired location, that is, the location where the user is lost, for example.

It would be therefore convenient to have a system or device that can be easily operated by any common person without skillfulness in the art, a tourist for example, and that provides all the required information of a desired location in the globe, even the real geographic images of the area wherein the user is staying.

3. Summary of the Invention

It is therefore one object of the present invention to provide a device for displaying an image of a desired area in the globe, which image is provided duly oriented according to the cardinal points, and can be zoomed in such an extent that any desired detail in the area is displayed, also showing the land sites and locations of interest. Thus, the inventive device allows to importantly save time, money, energy, fuel, etc. when looking for a location because the place is more easily and rapidly located without the need of any expertise in the manipulation of this kind of devices, with the possibility of carrying out these localization and identification of areas in automatic way by means of vehicles and/or robots, either of the tele-controlled or autonomous type.

It is still another object of the present invention to provide a device for displaying global images, that can be put in practice by any person without expertise in the art and that can be manufactured with simple components already available in the market.

It is a further object of the present invention to provide a device for displaying global images with the purpose of providing a solution to whom desires or needs to precisely determine and see his/her geographic position in any place of the earth planet, the device providing the means for planetary view, orientating and localizing of a desired place, the device comprising a combination of components operating in an automatic manner, with the complexity of the mechanisms hidden to the user, providing to the user a clear and real image of the planet, which image is initially orientated in the real orientation thereof in the globe. In addition, the image can be zoomed in order to see the same in a larger scale or reduced to a small scale according to the wishes or needs of the user to have a view of a detail or a general view of the place, the device comprising a geographic positioning device, one or more images collecting devices and an images displaying device, among other systems. These components can also interact with other communication systems, and the displaying of images may be of visual, auditive or tactile type, without the need of guide or information services.

It is still another object of the present invention to provide a device for displaying global images, that can be stationary and its position relative to the four cardinal points may be determined; or the device may be mobile, thus having the capability of being rotated or orientated, using a geographic orientation device with a function similar o a compass, thus obtaining the real orientation of the device.

It is a further object of the present invention to provide a device for displaying images of any desired location with the purpose of orientation for an user and for identifying and localizing any desired site, either at land, sea or air, either in the globe, a planet and space, the device comprising a device for displaying an image of the site; an image control device, a device for providing an orientation about the four cardinal points to the image control device, a receiver for receiving signals from a transmission network, and a processor for data from the transmission network.

It is even another object of the present invention to provide a global images displaying device for use in a global transmission network, for displaying images of any desired location with the purpose of orientation for an user and identifying, surveying, and localizing a desired site, the device comprising image displaying means for displaying at least one geographic image of the desired area; an image control device connected to the displaying means, a geographic orientation device connected to the image control device for providing an orientation about the four cardinal points to the image control device, a communication receiver for receiving signals from the transmission network, and a processor for controlling/coordinating data from the transmission network.

The above and other objects, features and advantages of this invention will be better understood when taken in connection with the accompanying drawings and description.

### BRIEF DESCRIPTION OF THE DRAWINGS

The present invention is illustrated by way of example in the following drawings wherein:

FIG. 1 shows a diagrammatic view of the globe with a person, buildings and transport means in the planet, and satellites in the space, all means today available and known in the art;

FIG. 2 shows a diagrammatic view of the globe with an enlarged detail of a globe area showing an urban area with a person lost in the area, buildings and vehicles;

FIG. 3 shows a diagrammatic view similar to FIG. 1, with a satellite provided with images recording means, signal transmission means, a person and a device according to the invention;

FIG. 4 shows a diagrammatic view similar to FIG. 3, with low orbit global satellites, a high orbit satellite provided with images recording means, signal transmission means, a person and a device according to the invention;

FIG. 5 shows a diagrammatic view of a device of the invention, with components of the electronic circuits employed in the device, and a planet image displayed according to the invention;

FIG. 6 shows a diagrammatic view similar to FIG. 5, but with the device using an alternative image display; and

FIGS. 7A-7D shows several views obtained according to the invention, with different zoom degrees.

### DESCRIPTION OF THE PREFERRED EMBODIMENTS

First, in all the Figures the same reference numbers indicate the same or equivalent components.

Referring in detail to the drawings it may be seen from the several Figures that the several means such as the global displaying means, orientation means and localization means are combined according to the invention and also comprise combined devices.

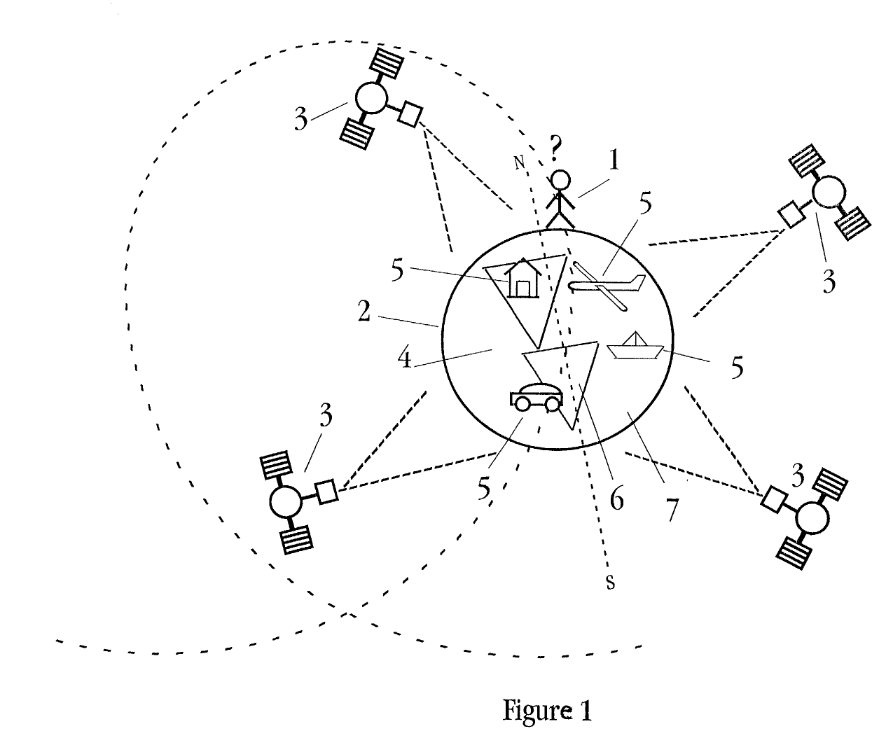

FIG. 1 schematically shows a person 1 that is staying in any area, region, place or location in earth plane or globe 2, this person unknowing his/her cardinal orientation and geographic position. Satellites 3 are in orbit around the globe and comprises visualization means capable of recording and transmitting signals corresponding to images taken from ground surface 4 of planet 2 by means of digital video cameras mounted in the satellites. On surface 4 of planet 2, or close to relative positions thereof, several elements such as buildings, ground vehicles, ships and planes, all indicated by reference number 5, which elements may be localized by the person by determining their geographic position, either on the ground 6, the sea 7 or air, which regions or areas are indicated in generic way just for illustrative purposes. The inventive device provides all the means for such person to find out and see in an easy and rapid way the position of any of such elements.

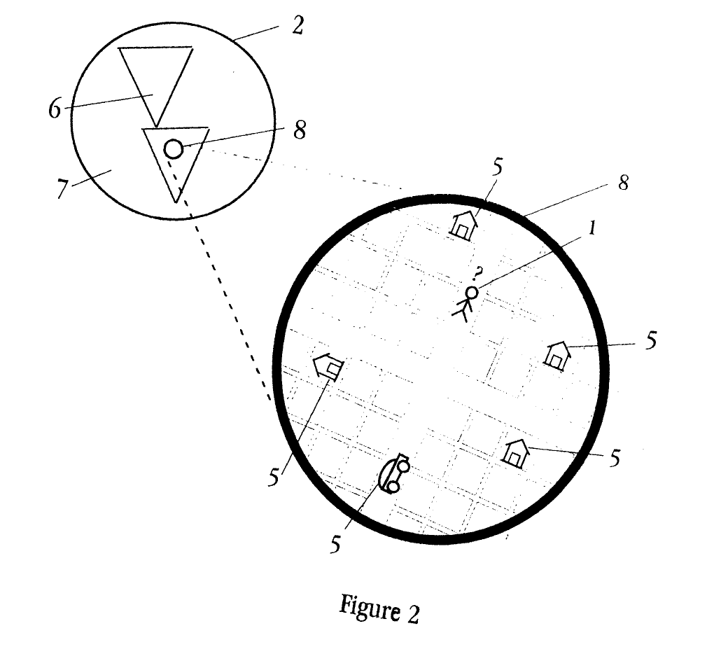

A situation similar to that one above disclosed is illustrated in FIG. 2. In this event, person 1 is located at a urban zone 8 which is enclosed and enlarged in a circle. Again, this person is lost and does not known his/her own position and orientation in the globe. Elements 5 that are desired to be located, represented by buildings and vehicles, are close to such person, however, the lack of orientation of the person and the lack of knowledge of the related area makes the person to not find such elements. Since the person has no knowledge of the region a large amount of resources may be wasted such as time, energy, fuel, money, etc. because the person has no a detailed plane of the region and, while the looked for elements may be close to the person, these elements 5 appear hidden to him/her.

The enlarged image of urban zone 8 as displayed by the inventive device is shown already coinciding with the real physical aspect of the region and its cardinal orientation, as it is in the real planet 2.

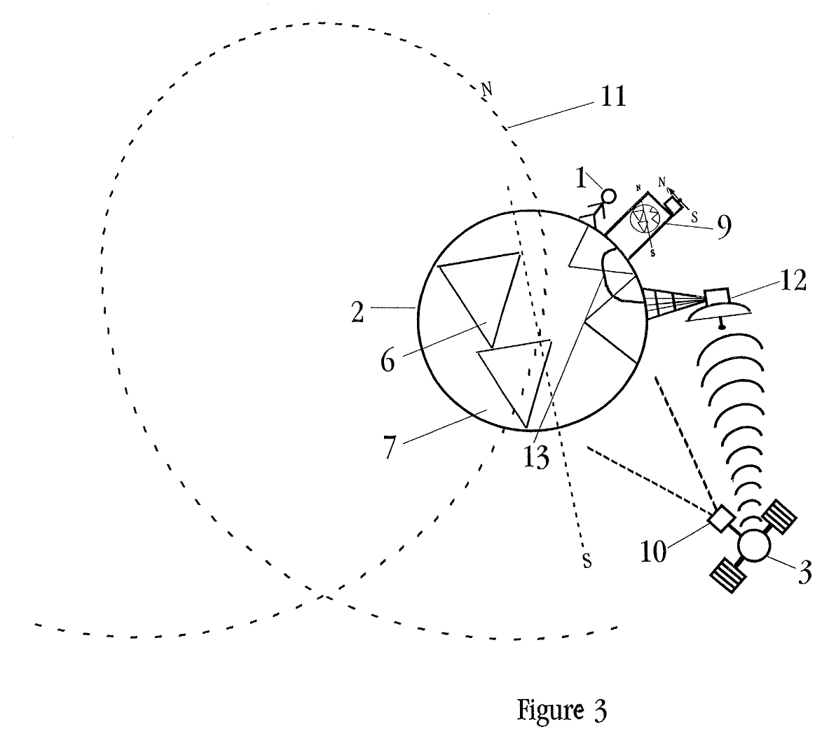

FIG. 3 shows the person staying in any region of planet 2 using a device according to the invention, now indicated by reference number 9 and comprising a stationary user terminal, that is the terminal is fixed in a determined point on the ground, such as a public telephone.

The surface of planet 2, and details thereof, either at sea, ground or air, is registered by an image registering device, such as a digital video camera 10 that is mounted in satellite 3 moving along orbit 11. The images taken by camera 10 are transmitted from satellite 3 and are received by a wireless transmission device 12 and, then, by a wire transmission device 13. This kind of transmission, first a wireless transmission and, then, a wire transmission of signals is disclosed only with exemplary purposes.

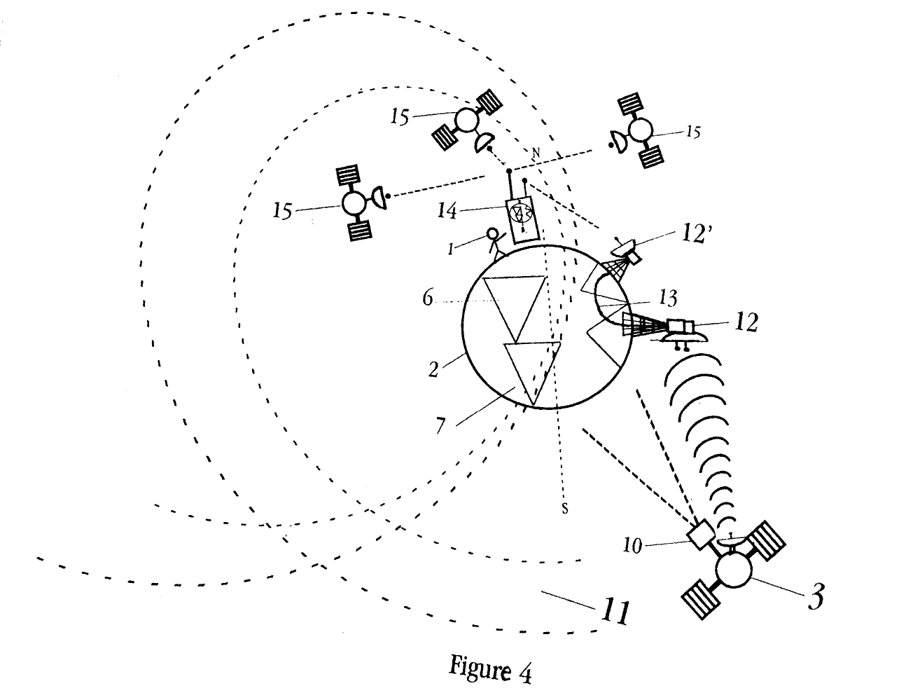

FIG. 4 illustrates a situation similar to the one of FIG. 3 but with a mobile version of the inventive device. Again, person 1 staying in a location of the planet is finding out his/her location by means of a mobile user terminal 14. The images are again registered by an image recording device 10 at satellite 3 in orbit 11, the images taken by this device being transmitted to the earth by wireless transmission device 12 and, then, by wire transmission device 13 and, finally re-transmitted by another wireless transmission device 12′ that sends the corresponding signals to user terminal 14.

Since the embodiment illustrated in FIG. 4 is a mobile version of the inventive device, it is necessary to determine the global position of the user/device by using, for example, any known geographic positioning system, and the geographic position may be manually entered by the person using the inventive device. Just as an example, FIG. 4 shows a global positioning system comprising emitting satellites 15 for emitting signals to a receiver that is part of the invention. According to the device of the invention, the image is projected or displayed reproducing the real aspect of the planet area and the corresponding cardinal orientation.

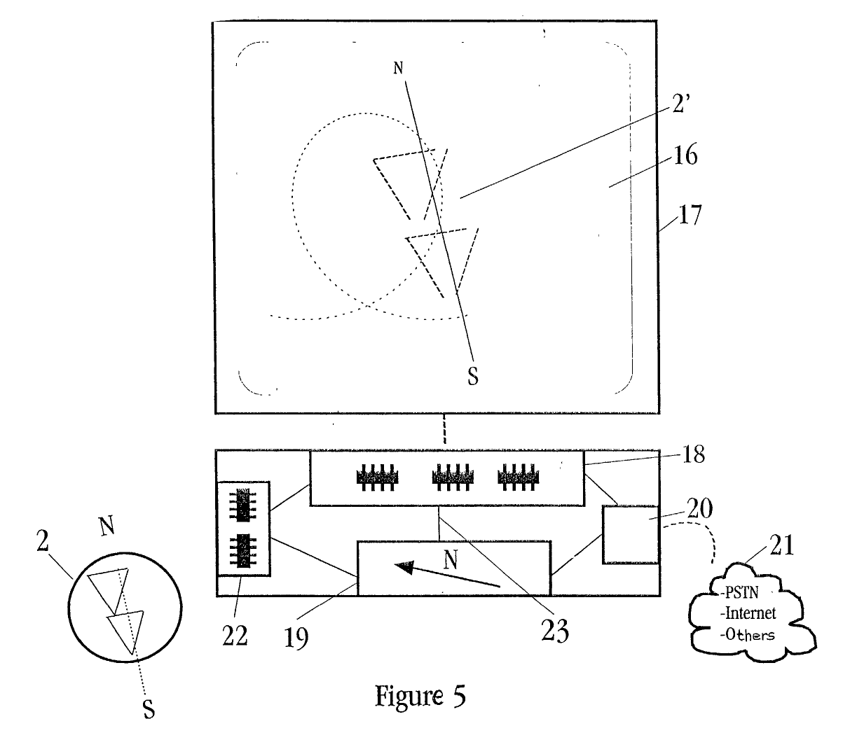

FIG. 5 schematically shows a detail of the main components in an user terminal of the invention. In effect, image 2′ of planet 2 is shown in screen 16 of an image displaying means or device comprising, in this embodiment, a computer display 17 in a user terminal. The image is controlled by an image control device connected to the displaying means, the control device comprising preferably a computer video-controlling board 18.

The geographic orientation of the device and the image is achieved by a geographic orientation device connected to the image control device for providing an orientation about the four cardinal points to the image control device. The orientation device may comprise an electronic compass 19. The reception of images is carried out by a communication device, such as a communication receiver for receiving signals from the transmission network, this receiver being preferably a network interphase board 20 that is connected to a transmission network 21. The communication receiving device is capable of receiving satellite signals, particularly the video signals from the digital video camera provided in the satellites, in association with the receiver.

The assembly is controlled/coordinated by a processor set and associated circuits, for controlling and/or coordinating data from the transmission network. The processor is computer motherboard 22. The assembly is also interconnected by interconnection lines 23 comprising a computer data bus. No specific description is provided of each of these components as long as the same may be obtained in the marked among a variety of types and are well known.

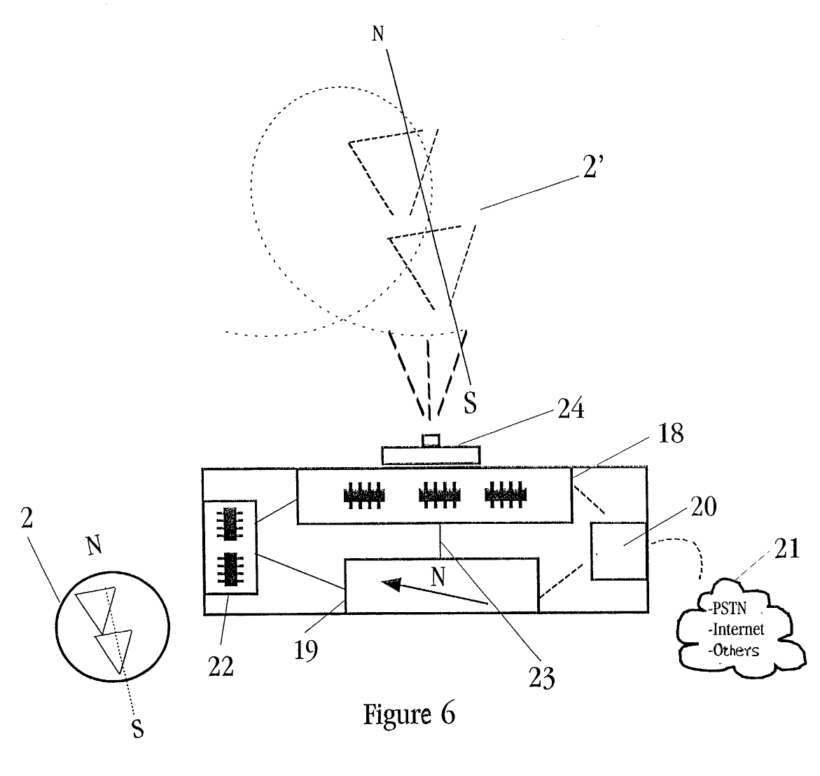

FIG. 6 shows a diagrammatic view of a user terminal according to the invention, the terminal being similar to that one of FIG. 5, but with the images 2′ of planet 2 displayed by means of an images projector, for example, a holographic projector 24 including control electronics. The remaining components, such as geographic positioning device 19, network inter-phase device 20, network 21, control device 22 and interconnecting lines 23, remains the same like in the other embodiments, for example that one of FIG. 5.

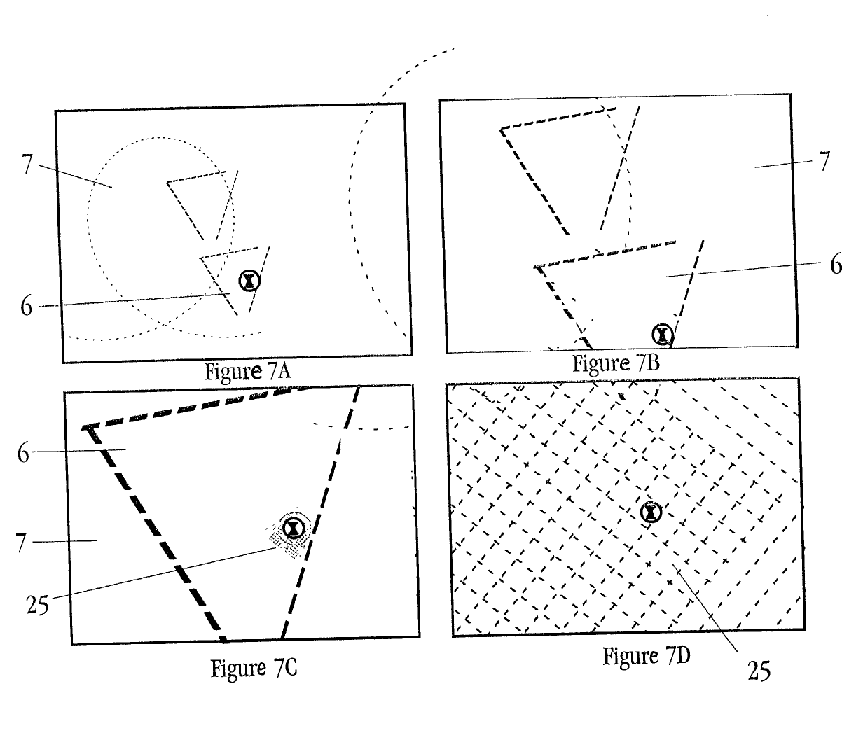

FIGS. 7A-7D shows several exemplary images as they are projected or displayed according to different zoom degrees from the image recorded satellite or satellites 3. Letter [symbol] X [symbol] within a circle indicates a point of interest the geographic position thereof can be easily determined by the device of the invention.

The image of FIG. 7A, obtained from a predetermined region of the planet may be part of, or the entire view of, a continent with reference 6 indicating the ground and reference 7 indicating the sea.

The image displayed in FIG. 7B corresponds to the same region of planet 2 indicated in FIG. 7A, but the image is enlarged, that is the image provides a closer approximation to the planet ground surface, as compared to the image of FIG. 7A.

The image illustrated in FIG. 7C also corresponds to the same area of FIGS. 7A and 7B but with a closer approximation to the surface ground, thus showing an upper view of an urban area.

Finally, FIG. 7D shows an image corresponding to the same area illustrated in FIGS. 7A-7C but with a closer approximation to the object that is desired to be displayed, in this event the urban area 25 is shown closer to the blocks of a city, with the blocks and streets clearly defined in the image. With this closer definition of the area or region, any element such as a building, a square, a street, even an address or a mobile element may be localized by the user or the device for different purposes.

While preferred embodiments of the present invention have been illustrated and described, it will be obvious to those skilled in the art that various changes and modifications may be made therein without departing from the scope of the invention as defined in the appended claims.

We claim:

1. Global images displaying device for use in a global transmission network, for displaying images of any desired location with the purpose of orientation for an user and identifying, surveying, and localizing a desired site, the device comprising:
image displaying means for displaying at least one geographic image of the desired area;
an image control device connected to the displaying means,
a geographic orientation device connected to the image control device for providing an orientation about the four cardinal points to the image control device,
a communication receiver for receiving signals from the transmission network, and
a processor for controlling/coordinating data from the transmission network.

2. The device of claim 1, wherein said image displaying means, said image control device, said geographic orientation device and said receiver are interconnected through interconnection lines.

3. The device of claim 1, wherein said image displaying means comprises a computer display in a user terminal.

4. The device of claim 1, wherein said image displaying means comprises a holographic projector including control electronics.

5. The device of claim 1, wherein said image control device comprises a computer video-controlling board.

6. The device of claim 1, wherein said geographic orientation device comprises an electronic compass.

7. The device of claim 1, wherein said processor is computer motherboard.

8. The device of claim 2, wherein said interconnection lines comprise a computer data bus.

9. The device of claim 1, wherein said receiver is a network inter-phase board.

10. The device of claim 9, wherein said receiver includes a satellite signal receiver, wherein a satellite with a digital video camera is provided in association with the receiver.
